(19) United States
(12) Patent Application Publication
(10) Pub. No.: US 2013/0204535 A1
(43) Pub. Date: Aug. 8, 2013

(54) VISUALIZING PREDICTED AFFECTIVE STATES OVER TIME

(71) Applicants: Ashish Kapoor, Kirkland, WA (US); Amy Karlson, Bellevue, WA (US); Mary P. Czerwinski, Kikland, WA (US); Asta Roseway, Bellevue, WA (US); Daniel Jonathan McDuff, Cambridge, WA (US)

(72) Inventors: Ashish Kapoor, Kirkland, WA (US); Amy Karlson, Bellevue, WA (US); Mary P. Czerwinski, Kikland, WA (US); Asta Roseway, Bellevue, WA (US); Daniel Jonathan McDuff, Cambridge, WA (US)

(73) Assignee: Microsoft Corporation, Redmond, WA (US)

(21) Appl. No.: 13/365,265

(22) Filed: Feb. 3, 2012

(51) Int. Cl. G06F 19/00

(52) U.S. Cl. 702/19

(57) ABSTRACT

Described herein are various technologies pertaining to estimating affective states of a user by way of monitoring data streams output by sensors and user activity on a computing device. Models of valence, arousal, and engagement can be learned during a training phase, and such models can be employed to compute values that are indicative of valence, arousal, and engagement of a user in near-real time. A visualization that represents estimated affective states of a user over time is generated to facilitate user reflection.

### BACKGROUND

Life expectancy of humans has continued to increase, due at least in part to increased recognition of the importance of monitoring health; both physical and emotional. For example, studies have shown that consistent, moderate physical exercise can increase life expectancy of an individual by several years. Additionally, screening for certain types of diseases increases life expectancy, as recognizing certain diseases early in development allows for more effective treatment. Currently, there are several relatively inexpensive tools that can employed by people to monitor varying aspects of their physical health, such as scales to monitor weight over time, blood pressure sensors to track blood pressure over time, amongst others.

Monitoring emotional health, however, is more problematic, at least partially due to difficulties in recognizing, quantifying, logging, and remembering affective states. For instance, an individual may have difficulty recognizing a current affective state, much less making decisions that facilitate improving emotional health. Conventionally, people have used diaries to facilitate reflection on affective states, such that over time a person can review diary entries to infer and reflect over previous affective states. Using a diary, however, does not assist in quantifying affective states, and further may not facilitate recognition of causes of certain affective states.

### SUMMARY

The following is a brief summary of subject matter that is described in greater detail herein. This summary is not intended to be limiting as to the scope of the claims.

Described herein are various technologies pertaining to visualizing affective states of a user over time. With more particularity, described herein are various technologies pertaining to estimating affective states of the user over time based upon received sensor signals, and generating a visualization that facilitates user reflection over the estimated affective states. In an exemplary embodiment, models of affective states of users can be built based upon labeled training data. In a particular example, models of the affective states of valence, arousal, and engagement can be built, wherein the state of valence is indicative of an intrinsic feeling of positiveness or negativeness during a window of time; r, the state of arousal is indicative of an intensity of the feeling of positiveness or negativeness during the window of time, and the state of engagement is indicative of the cognitive engagement of the user during the window of time. Such models can be learned by configuring a plurality of sensors to capture data streams of different users and periodically receiving quantitative assessments of their respective feelings of valence, arousal, and engagement. For instance, for a particular period of time (e.g., 15 minutes) the users can submit values (in accordance with a standardized scale) for valence, arousal and engagement, respectively. Such values can be normalized and assigned to data generated by the sensors, and models of states of valence, arousal, and engagement can be learned through any suitable machine learning technique.

These models of affective states can then be employed to estimate affective states of valence, arousal, and engagement of users in real-time or near real-time. Specifically, a plurality of sensors can be configured to sense various conditions of a user, and data streams from the sensors can be utilized to compute values that are indicative of the valence, arousal, and engagement of the user for a particular window of time (e.g. 15 minutes). For example, sensors can be configured to capture facial expressions of the user, location of the user, posture of the user, voice of the user, electro-dermal activity of the user, etc. Furthermore, activity of the user on computing devices can be tracked over time, including web pages visited by the user, applications employed by the user, people with whom the user interacted (e.g. via e-mail, instant messaging application, or in a meeting), etc. Based upon the data received from the sensors, values indicative of valence, arousal, and engagement of the user can be computed over time.

A visualization is then rendered that graphically represents the affective states of the user over some specified time window/granularity. The time window can be selected by the user as well as the time granularity. Accordingly, for instance, the user may wish to view her affective states over the past year on a month-by-month basis. In another example, the user may wish to be provided with a visualization that allows her to reflect on her estimated affective states over the course of a day, broken down by the hour. The visualization can include a plurality of graphical objects that are indicative of affective states of the user over various windows of time. For instance, the size, shape, opacity, color and/or the like of a graphical object can be indicative of valence, arousal, and engagement of the user during a particular window of time.

Still further, the visualization can be interactive in nature, such that the user can traverse through different windows and/or granularities in time. Furthermore, the user can explore certain windows in time in an effort to understand causes of the estimated affective states. For example, the activity of the user can be tracked over time, and selection of a particular graphical object (that represents valence, arousal, and/or engagement of the user for a particular window of time) in the visualization can cause data to be presented to the user that corresponds to the window of time. This data can illustrate to the user what the user was doing during the window of time, with whom the user was interacting during the window of time, and the like. Thus, the user can not only reflect on her affective states over specified windows of time and granularities, but can also explore activities undertaken by the user that correspond to estimated affective states, thereby facilitating understanding the reasons for the affective states. This in turn can improve the emotional health of the user, as the user can consciously make decisions that can improve at least partially subconscious affective states

Other aspects will be appreciated upon reading and understanding the attached figures and description.

### BRIEF DESCRIPTION OF THE DRAWINGS

FIG. 1 is a functional block diagram of an exemplary system that facilitates generating a visualization of estimated affective states of a user over time.

FIG. 2 is an exemplary graphical user interface that depicts estimated affective states of a user over time.

FIG. 3 is an exemplary graphical user interface that facilitates presenting data to a user that corresponds to an estimated affective state.

FIG. 4 is a functional block diagram of an exemplary system that facilitates retrieving data based at least in part upon an estimated affective state of a user.

FIG. 5 is a functional block diagram of an exemplary system that facilitates providing a search engine with data that is indicative of a current affective state of a user.

FIG. 6 is a functional block diagram of an exemplary system that facilitates learning of models of affective states of valence, arousal, and engagement.

FIG. 7 is a flow diagram that illustrates an exemplary methodology for generating a visualization that represents user valence, arousal, and engagement over time.

FIG. 8 is an exemplary computing system.

### DETAILED DESCRIPTION

Various technologies pertaining to estimating and visualizing affective states of a user will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

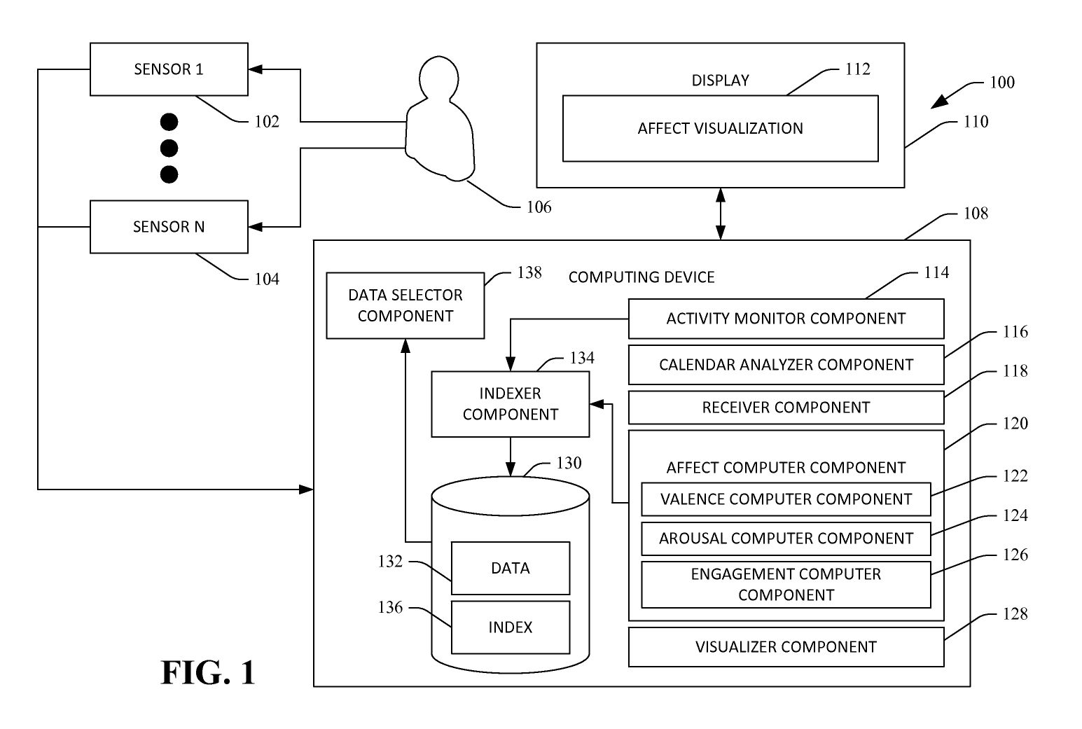

With reference now to FIG. 1, an exemplary system 100 that facilitates generating a visualization of affective states of a user over time is illustrated. The term “affect” is used herein in accordance with its standard meaning in the field of psychology, such that affect refers to the experience of feeling or emotion. The system 100 comprises a plurality of sensors 102-104 that are configured to sense at least one condition of a user 106. The system 100 additionally comprises a computing device 108 that receives data streams output by the sensors 102-104. As will be described in detail below, the computing device 108 is programmed to compute values that are indicative of at least one affective state of the user 106, and is further programmed to generate a visualization that depicts the at least one affective state of the user 106 over time in time windows of granularity selected by the user 106. The system 100 further comprises a display 110 that receives the visualization from the computing device 108 and displays an affect visualization 112 to the user 106.

With more particularity, the computing device 108 can be programmed to compute values that are indicative of the affective states of valence, arousal, and engagement of the user 106 over time based at least in part upon the data streams received from the sensors 102-104. As used herein, the term “valence” refers to an intrinsic feeling of the user of positiveness or negativeness during a window of time, the term “arousal” refers to an intensity of the feeling of the user during the window of time, and the term “engagement” can refer to the cognitive engagement of the user 106 during the window of time. Length of the window of time can be any suitable length, such as five minutes, ten minutes, fifteen minutes, thirty minutes, an hour, a day, a week, a month, etc.

The sensors 102-104 can include any suitable type of sensor that can sense one or more conditions of the user 106. Pursuant to an example, the sensors 102-104 can include a video camera (e.g., a web cam), a depth sensor, a microphone, an electro-dermal activity (EDA) sensor, and a portable global positioning system (GPS) sensor that tracks the location of the user 106 over time. The video camera can be directed at the user 106 and capture video of the face of the user 106. Facial actions such as smiles, frowns, eyebrow raises head nods, head shakes, and the like are good indicators of valence (positive versus negative) of the user 106. Accordingly, the video camera can output video and facial actions and head motion can be analyzed, and value(s) indicative of affective state(s) can be computed based at least in part upon such analysis. In an exemplary embodiment, an active appearance model can be employed to track feature points on the face of the user 106, Euler angles for pitch, yaw and roll of the head, and X, Y, and Z displacement of the head within a frame of video.

The depth sensor can be employed to analyze posture of the user 106. Posture, for instance, can be an indicator of interest levels (engagement). For example, a person highly engaged in a task can be expected to maintain a relatively still, upright posture when compared to fidgets and slouched posture of a disengaged person. The depth sensor (possibly in connection with the video camera) can be employed to record posture features of the user 106, such as for instance, amount and direction of lean (left to right and forward to back) of the user 106.

The microphone can capture speech of the user 106, which can be a rich modality in terms of affect. Information extracted from speech of the user 106, for instance, can include change in prosody, structure of pauses, relative volume of the speech of the user 106, and the exhalation of breath. Such information can be indicative of the affective state of the user 106, particularly with respect to of arousal and valence.

The EDA sensor can be particularly effective in connection with detecting arousal. For example, the EDA sensor can be configured as a wearable wrist sensor to record electro-dermal activity, as well as 3 axis acceleration of the wrist of the user 106.

While several exemplary sensors that can be included in the system 100 have been set forth above, it is to be understood that the sensors 102-104 may include a variety of different types of other sensors, particularly those that are configured to sense physiological conditions of the user 106. Thus, in addition to the sensors mentioned above, the sensors 102-104 may include a heart rate monitor, a blood pressure monitor, an electrode, or any other suitable sensor. Further, the sensors 102-104 can output signals in real-time. In alternative embodiments, the sensors 102-104 may have local data storage associated therewith, such that the sensors 102-104 can output data periodically or when queries by the computing device 108.

Moreover, it is to be understood that the user 106 has knowledge of the data that is being captured by the sensors 102-104 and provided to the computing device 108, and has consented to being monitored via the sensors 102-104. Additionally, the user 106 can readily disable one or more of the sensors 102-104 if the user 106 feels the need for enhanced privacy or feels that the sensors 102-104 are in some way intrusive.

The computing device 108 may have several applications installed thereon, such as but not limited to a web browser, an e-mail client, an instant messaging application, a word processing application, a spreadsheet application, a slideshow application, or any other suitable application. The computing device 108 optionally includes an activity monitor component 114 that monitors activity of the user 106 with respect to applications and/or documents on the computing device 108. As used herein, the term “documents” is intended to encompass web pages, word processing documents, files, executables, and the like. Accordingly, the activity monitor component 114 can identify people with whom the user 106 is communicating, documents that the user 106 is accessing, etc. In an exemplary embodiment, the computing device 108 can compute values that are indicative of affective states of the user 106 based at least in part upon activities of the user 106 on the computing device 108 as monitored by the activity monitor component 114. For example, a task that the user 106 is working on can be informative as to the level of engagement of the user 106 (as well as valence and arousal). Similar to the sensors 102-104, the user 106 has knowledge as to the monitoring being undertaken by the activity monitor component 114 and has the ability to disable the activity monitor component 114 readily when desired.

The computing device 108 may also optionally include a calendar analyzer component 116 that can analyze entries in a calendaring application on the computing device 108, wherein such entries, for instance, can identify people with whom the user 106 is meeting or has met with in the past, locations of meetings, and times of meetings. It can be appreciated that interaction with certain people is a relatively large factor in affective states; therefore identities of people with whom the user 106 can be indicative of valence, arousal, and engagement of the user 106 when the user 106 is interacting with such people. It is again to be understood that the user 106 can disable operation of the calendar analyzer component 116, and can further control operation thereof such that specified calendar entries are ignored by the calendar analyzer component 116.

The computing device 108 additionally comprises a receiver component 118 that receives data streams output by the sensors 102-104, data output by the activity monitor component 114 and/or data output by the calendar analyzer component 118. An affect computer component 120 is in communication with the receiver component 118 and computes values that are indicative of affective states of the user 106 based at least in part upon the data streams received from the sensors 102-104, the data output by the activity monitor component 114, and/or the data output by the calendar analyzer component 116.

The affect computer component 120 can include a valence computer component 122, an arousal computer component 124, and an engagement computer component 126. The valence computer component 122 is configured to output values that are indicative of valence of the user 106 over time based at least in part upon data streams output by the sensors 102-104, data output by the activity monitor component 114, and/or data output by the calendar analyzer component 116. The valence computer component 122 can be or include a learned valence model, which, as will be described below, can be learned based at least in part upon labels generated by users during a training phase. Such model can be or include an artificial neural network, a Bayesian model, a regression tree, or other suitable model.

The arousal computer component 124 is configured to compute values that are indicative of arousal of the user 106 over time based at least in part upon data streams output by the sensors 102-104, data output by the activity monitor component 114, and/or data output by the calendar analyzer component 116. The arousal computer component 124 can include a learned model of arousal, wherein such model is learned based at least in part upon labeled training data that indicates arousal levels of users over time. The learned model of arousal can be an artificial neural network, a linear regression tree, a Bayesian model, or the like.

The engagement computer component 126 computes values that are indicative of engagement of the user 106 over time based at least in part upon data streams output by the sensors 102-104, data output by the activity monitor component 114, and/or data output by the calendar analyzer component 116. The engagement computer component 126 can include a learned model of engagement, wherein such model is learned based at least in part upon training data that is labeled to indicate engagement of users during a training phase. The learned model of engagement can be a regression tree, a Bayesian model, an artificial neural network, etc.

The computing device 108 further comprises a visualizer component 128 that generates a time-series visualization for display on the display 110 to the user 106. Such visualization can depict one or more affective states of the user 106 (as estimated by the affect computer component 120) over time, thereby facilitating user reflection of her affective states. Pursuant to an example, the visualizer component 128 can generate the affect visualization 112 such that it includes a plurality of graphical objects that correspond to different windows of time, wherein each of the graphical objects is rendered to be indicative of at least one of estimated valence, arousal, or engagement of the user 106 during a certain time window (with a granularity selected by the user 106). For example, the user 106 can indicate that she would like to the provided with a visualization of affective states over the course of a day during one hour time windows. The visualizer component 128 can receive values indicative of affective states of the user 106 from the affect computer component 120, for instance, for fifteen minute intervals over the course of the day. The visualizer component can aggregate and average data to generate the visualization requested by the user 106.

Moreover, the affect visualization 112 can be interactive such that the user 106 can obtain additional information pertaining to activities of the user 106 over a selected time window. In an example, the affect visualization 112 will include a graphical object, wherein the graphical object is configured to indicate to the user 106 estimated valence, arousal, and engagement of the user 106 over a certain window of time. The user 106 can select the graphical object, and responsive to selecting the graphical object, can be provided with additional information as to activities of the user 106 during the window of time. Thus, the user 106 can be provided with data that may indicate to the user 106 reasons for the affective states represented by the graphical object. In any event, the user 106 can reflect over computed affective states of the user 106 over time windows with time granularity selected by the user 106.

The computing device 108 also includes a data store 130, which may be a hard drive, memory, or the like. The data store 130 includes data 132 that identifies documents accessed by the user 106, people with whom the user 106 has interacted, and applications utilized by the user 106 on the computing device 108. Accordingly, the data 132 can include e-mails, instant messages, URLs, content of web pages reviewed by the user 106, etc.

The computing device 108 also optionally includes an indexer component 134 that can index at least a portion of the data 132 with respect to estimated affective states of the user 106 over time. Thus, the indexer component 134 can receive activities as monitored by the activity monitor component 114 and data output by the calendar analyzer component 116, and can further receive values that are indicative of valence, arousal, and engagement of the user 106 over time. The indexer component 134 may then generate an index 136 that indexes the data 132 by affective states of the user 106. In an illustrative example, the engagement computer component 126 may compute a value that indicates that the user 106 is highly engaged when the user 106 is editing a certain word processing document. The indexer component 134 can index the word processing document with respect to a high level of engagement. Thus, if the user 106 wishes to retrieve data corresponding to high levels of engagement, the user can readily do so through utilization of the index 136. The data 132 can likewise be indexed based upon values indicative of valence, and/or arousal (or some combination of valence, arousal, and engagement). If a particular file is accessed multiple times and has multiple different values of valence, arousal, and/or engagement assigned thereto, then the indexer component 134, in an exemplary embodiment, can index the file multiple times using the different values of valence, arousal, and/or engagement. In other embodiments, the indexer component 134 can index data based upon average valence, arousal, and/or engagement corresponding thereto.

This indexing of data with respect to affective states can help the user 106 to ascertain which projects, people, etc. cause the user 106 to have relatively positive affective states and/or negative affective states, thereby informing the user 106 of people and/or projects to pursue as well as people and/or projects to avoid.

The computing device 108 may also optionally include a data selector component 138 that selectively surfaces data for presentment to the user 106 amongst a relatively large collection of data. For example, in the affect visualization 112, it may be desirable to present to the user 106 one or more activities undertaken by the user 106 with respect to a window of time that corresponds to a particular computed affective state. That is, if the user 106 is found to be highly engaged over a certain window of time, it may be desirable to provide the user 106 with data that is believed to have at least partially contributed to the high level of engagement of the user 106. The data selector component 138 can select such data for presentment to the user 106 based upon, for example, uniqueness of the data relative to other data interacted with by the user 106 during the window of time corresponding to the computed affective state. In another example, the data selector component 138 can surface data to the user 106 based upon the weight given to such data by the affect computer component 120 when computing an affective state of the user 106. For instance, if the valence computer component 120 determined that the user 106 had a highly positive valence when communicating with a particular friend, then the data selector component 138 can receive such information from the valence computer component 122 and can surface e-mails to the individual 106 from such friend. When reflecting upon her affective state, the user 106, then, can ascertain that communication with the friend may cause the user 106 to experience a relatively high valence. Other factors that can be considered by the data selector component 138 can include manually labeled importance labels (e.g., e-mails labeled is important can be provided a larger weight when determining whether to surface an e-mail to the user 106), generally positive or negative tone of a document as ascertained by one or more natural language processing algorithms, or the like.

Additionally, the data selector component 138 can selectively surface data to the user 106 based upon a most recently computed affective state of the user. For example, if the affect component 120 outputs values that indicate that the user 106 is relatively unhappy, then the data selector component 138 can selectively surface data to the user 106 that may improve the emotional state of the user 106 (e.g., a document or e-mail that has been assigned high valence values, for example). In yet another example, the user 106 can identify close friends and/or family members, and the data selector component 138 can selectively inform such friends or family members of drastic changes in affective state of the user 106 and/or if values indicative of valence, arousal, and/or engagement fall outside of specified ranges. This can allow friends/family of the user 106 to provide an emotional lift to the user 106, if needed.

Is to be understood that while the computing device 108 is shown as being separate from the display 110, the computing device 108 may be included in a common housing with the display 110. Therefore, the combination of the computing device 108 and the display 110 may be included in a mobile telephone, a tablet computing device, a laptop computing device, or the like. In other embodiments, the computing device 108 and the display 110 may be physically separated.

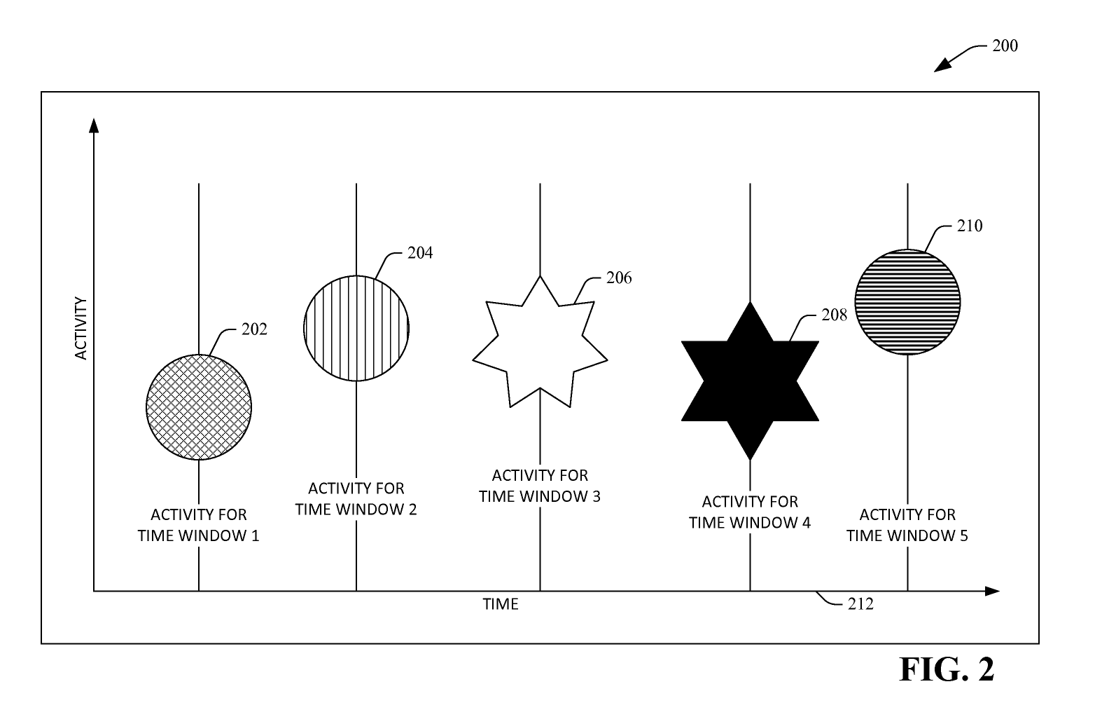

With reference now to FIG. 2, an exemplary graphical user interface 200 that illustrates a visualization of estimated affective state of the user 106 over time is shown. The graphical user interface 200 comprises a plurality of graphical objects 202-210, which are rendered along a timeline 212. The graphical objects 202-210 can be rendered with respect with respect to windows of time of specified granularity, such as 15 minutes, 30 minutes, an hour, etc. The graphical objects 202-210 can be rendered to provide the user 106 with indications of valence, arousal, and engagement of the user 106 for multiple windows of time. For example, a color assigned to a graphical object can be indicative of the estimated valence of the user 106 for a window of time. Similarly, estimated arousal of the user 106 during a certain window of time can be represented by shape of a graphical object, wherein a more circular shape is indicative of a lower amount of arousal. Estimated engagement of the user 106 for a window of time can be represented by opacity of a graphical object, with a higher opacity corresponding to a lower engagement.

In the exemplary graphical user interface 200, for each window of time, an amount of activity of the user 106 can be represented by a distance of respective graphical objects from the timeline 212 and/or size of the respective graphical objects. Therefore, the further a graphical object from the timeline 212, the more active the user 106 during the window of time. Furthermore, a subset of the activities themselves can be presented in graphical relation to the graphical objects 202-210. As described above, data to present in the graphical user interface 200 can be selected by the data selector component 138. The graphical user interface 200 may also include other graphical objects that indicate for instance, the general location of the user 106 along the timeline 212, whether the user 106 was in a meeting along the timeline, amongst other information.

Additionally, the user 106 can choose to selectively choose to reflect over estimated states of valence, arousal, and engagement at different time granularities. For example, graphical objects can be rendered in accordance with time windows of a first granularity (e.g., an hour). The user 106 may wish to view the graphical objects at more granular time windows; thus, the user 106 can select a graphical object that corresponds to a particular window of time (e.g., 1:00 μm to 2:00 μm). This can cause graphical objects to be presented to the user 106 that represent estimated states of valence, arousal, and engagement of the user 106 at more granular time windows (e.g., 15 minutes).

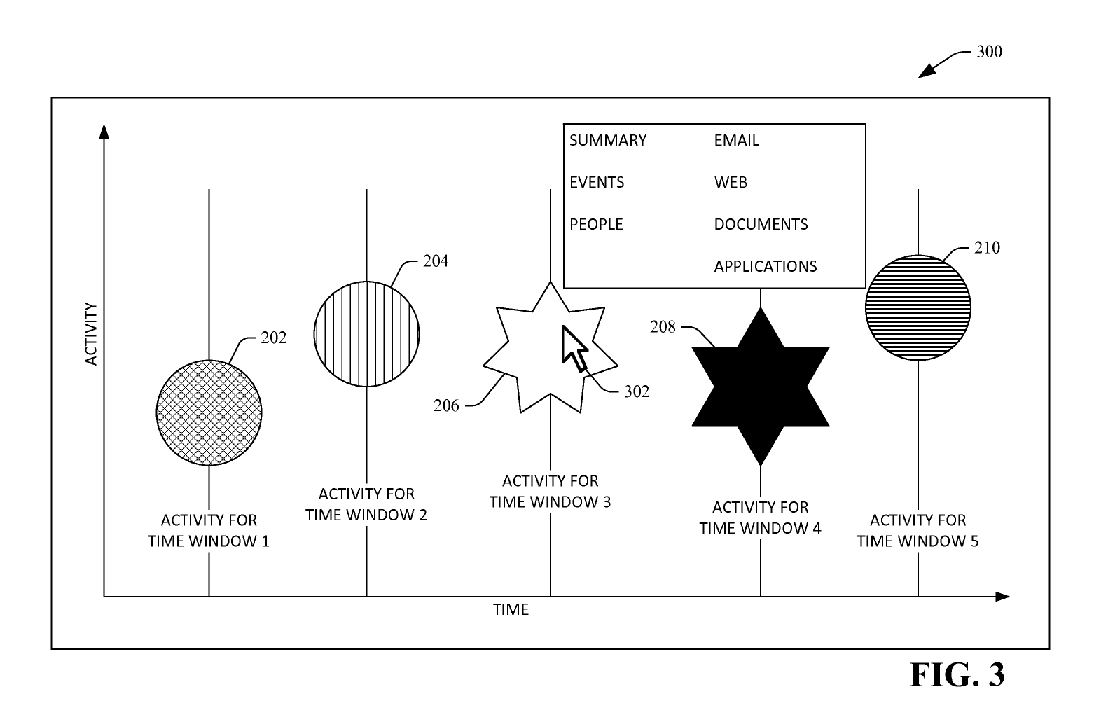

Now referring to FIG. 3, another exemplary graphical user interface 300 is shown. The graphical user interface 300 includes a cursor 302 that is employed by the user 106 to select one of the graphical objects (e.g., the graphical object 206). In an example, the user 106 can hover the cursor 302 over the graphical object 206. Responsive to detecting the hover, a window 304 can be presented in the graphical user interface 300, wherein the window 304 provides additional data pertaining to the graphical object 206. For instance, the window 304 can include a summary that summarizes the estimated valence, arousal, and engagement of the user for the third time window. The window 304 can also include events retrieved by the calendar analyzer component 116 to illustrate to the user 106 whether the user 106 was in one or more meetings during the third time window. The window 304 also includes identities of people that the user 106 interacted with during the 3rd time window.

The window 304 also comprises data that summarizes one or more e-mails received by the user 106 during the third time window. The window 304 may also include data that that identifies web pages viewed by the user 106 by way of a web browser during the third time window, one or more word processing documents that were accessed during the third time window, and/or identities of one or more applications are utilized by the user 106 during the third time window. The content of the window 304 can assist the user 106 in recalling the activities undertaken by the user 106 during the third time window, and may further assist the user 106 in ascertaining reasons for estimated states of valence, arousal, and/or engagement as represented by the graphical object 206.

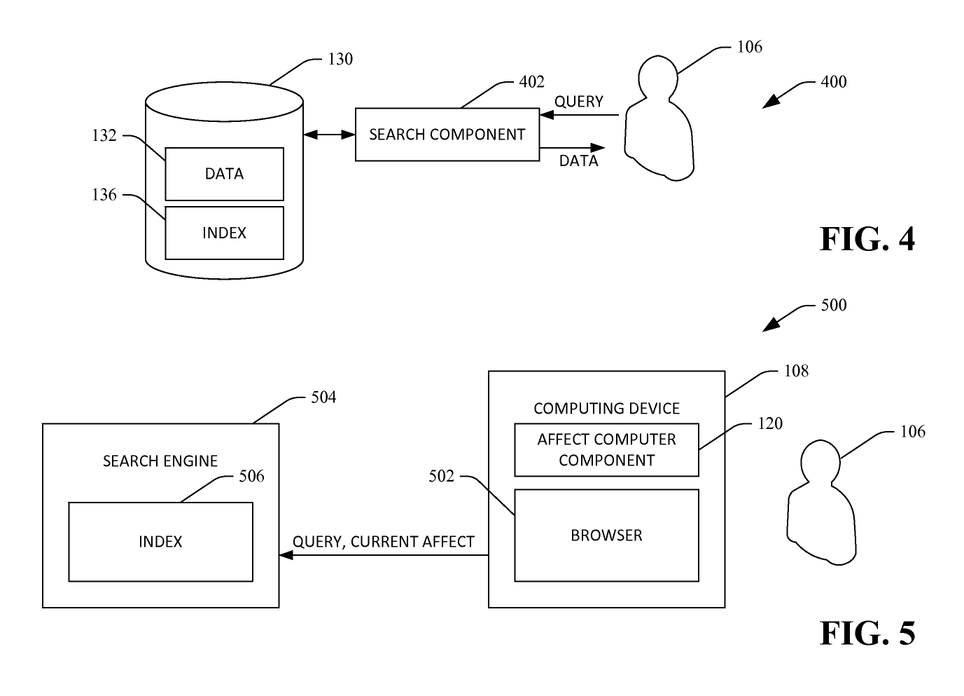

Now turning to FIG. 4, an exemplary system 400 that facilitates retrieval of data from a data repository based at least in part upon computed affective states of the user 106 is illustrated. The system 400 comprises the data store 130, which includes the data 132 and the index 136 that indexes the data 132 by affective states of the user 106 as computed by the affect computer component 120. The system 400 further comprises a search component 402 that is configured to retrieve data from the data 132 via accessing the index 136 responsive to receipt of a query from the user 106. The query proffered by the user 106 can include an indication of an affective state. For instance, the user 106 may wish to locate data that corresponds to a time window when the user 106 was highly engaged. Therefore, the query proffered by the user 106 to the search component 402 can include information that indicates that the user 106 wishes to retrieve data that has been assigned relatively high engagement values. The retrieved data can include an identity of one or more persons, files interacted with by the user 106, applications employed by the user 106, or the like. Retrieving data based upon affective states can assist in aiding the user 106 in recalling activities undertaken by the user 106 when the user 106 was highly engaged, or had a high valence, or was particularly excited about something, and may further assist the user 106 in making future decisions regarding certain activities or people.

Referring now to FIG. 5, an exemplary system 500 that facilitates providing a search engine with a query that has been tagged with a computed affective state of the user 106 is illustrated. The system 500 includes the computing device 108, which comprises the affect computer component 120. The affect computer component 120 can receive data from the sensors 102-104 as well as data output from the activity monitor component 114 and the calendar analyzer component 116, and can compute affective states of the user 106 in near real-time.

The computing device 108 can include a browser 502 that is initiated by the user 106. The system 500 further includes a search engine 504 that is in communication with the computing device 108. Specifically, the browser 502 on the computing device 108 is directed towards the search engine 504 by providing the browser 502 with a URL corresponding to the search engine 504. The search engine 504 includes an index 506 of documents that are available by way of the World Wide Web. The user 106 provides the search engine 504 with a query that is configured to retrieve one or more documents that are of interest to the user 106. The browser 502 additionally receives values that are indicative of most current affective states of the user 106, and transmits the query and the values to the search engine 504. The search engine 504 searches the index 506 based at least in part upon the query and the values, and returns a ranked list of search results based at least in part upon the query and the affective states of the user 106.

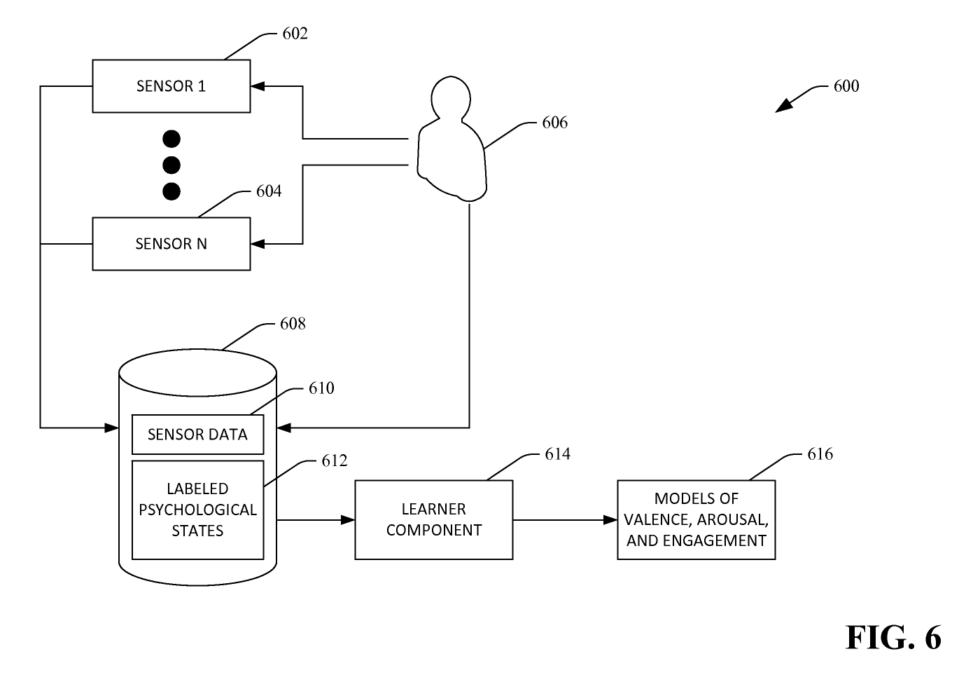

With reference now to FIG. 6, an exemplary system 600 that facilitates learning models of valence, arousal, and engagement for employment by the affect computer component 120 is illustrated. The system 600 comprises a plurality of sensors 602-604, which are configured to sense one or more conditions of a user 606 during a training phase. The system 600 further comprises a data repository 608 that is in communication with the sensors 602-604, wherein the data repository 608 retains data streams output by the sensors 602-604. These data streams output by the sensors 602-604 can be normalized, wherein the normalized data is retained as sensor data 610. In an example, the sensors 602-604 can include a video camera, and two-dimensional variations due to rotation, displacement, and scaling can be removed. Moreover mean from axes of rotation and mean from axes of displacement computed based upon video frames generated by the video camera can be removed. The sensors 602-604 may also include a depth sensor and/or skeletal tracker, wherein mean lean (left to right and front to back) can be removed during normalization. The sensors 602-604 can also include an EDA sensor, and the mean value can be removed and low-pass filtering can be undertaken during normalization. Likewise, mean and unit standard deviation of an accelerometer can be accounted for during normalization.

The normalized sensor data 610 can then be analyzed to extract/calculate features. These features can include, for example, a smile intensity, eyebrow activity, mouth activity (for every time window) pitch, roll, and yaw of the head of the user 606, X, Y and Z displacement of one or more body parts of the user 606 from a mean, a length of a conversation, a number of turns in a conversation, a number of zero crossings, a normalized frame energy, gradient index, local kurtosis, spectral centroid, etc. can be computed. The gradient of the lean of the user 606, from front to back and side to side, can be computed as well as numerous other features. Again, such features can be retained in the data repository 608.

The user 606 can then self-report affective states over certain time windows. That is, the user 606 can report her valence, arousal, and engagement levels at regular intervals over the course of a day using a standard scale. For instance, the labels can be numerical values between −1 and +1 for valence, arousal, and engagement respectively. When received from multiple users, values of valence, arousal, and engagement can be normalized and thresholded to form discrete classes (e.g. positive versus neutral versus negative; low versus high). Such discrete classes can be retained as labeled psychological states 612 in the data repository 608.

The system 600 further comprises a learner component 614 that can access the features and the labeled psychological states 612 to learn models of valence, arousal, and engagement 616. Such models can be Bayesian models, regression trees, artificial neural networks, or the like. In another embodiment, the features and the labeled psychological states 612 can themselves act as a model, and the affect computer component 120 can utilize a nearest neighbor classifier to compute values that are indicative of valence, engagement, and arousal, respectively. In such an embodiment, the affect computer component 120 can utilize a distance metric learning technique, such as Neighborhood Component Analysis. Neighborhood Component Analysis is configured to weight different features such that examples belonging to a same class will have a minimal distance therebetween, while examples belonging to different classes are as far apart as possible. In the system 600, separate distance metrics can be learned for each of the three different labels (arousal, valence, and engagement).

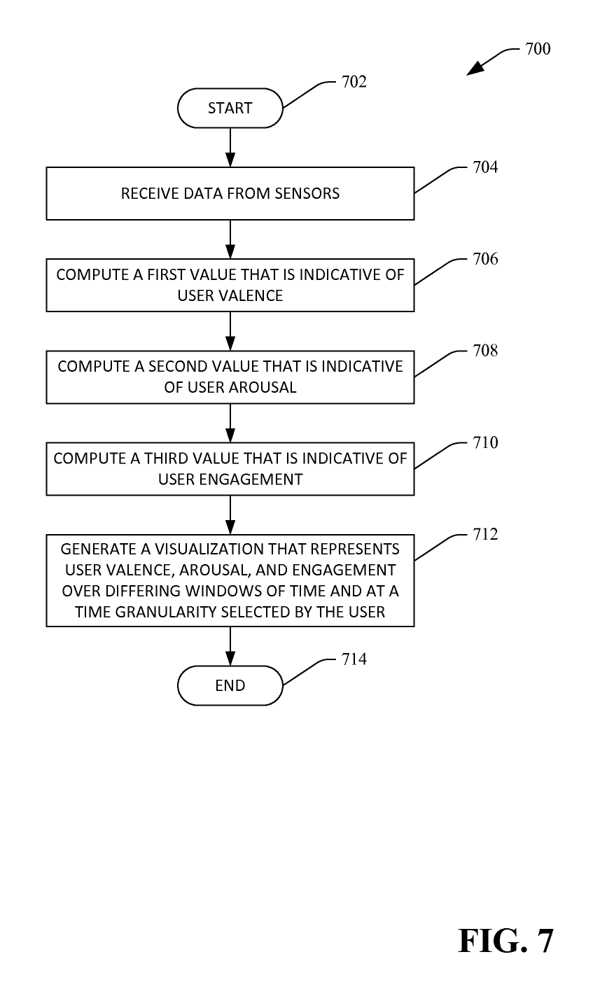

With reference now to FIG. 7, an exemplary methodology is illustrated and described. While the methodology is described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Turning now to FIG. 7, an exemplary methodology 700 that facilitates generating a visualization that represents user valence, arousal, and engagement over several windows of time with granularity selected by a user is illustrated. The methodology 700 starts at 702, and at 704 data is received from a plurality of sensors, wherein the data is indicative of at least one condition of the user. Moreover as described above, the sensors can include a video camera and a depth sensor.

At 706, a first value that is indicative of valence of the user is computed based at least in part upon the data received from the plurality of sensors. At 708, a second value that is indicative of arousal of the user is computed based at least in part upon the data received from the plurality of sensors. At 710, a third value that is indicative of engagement of the user is computed based at least in part upon the data received from the plurality of sensors.

These values (first value, second value, and third value) can be repeatedly computed over different time windows based upon sensor data receiving during the time windows. That is, the acts of receiving the data from the sensors, computing the first value, computing the second value, and computing the third value can be repeated numerous times to generate values that are indicative of valence of the user over time, values that are indicative of arousal of the user over time, and values that are indicative of engagement of the user over time.

At 712, a visualization is generated that graphically depicts valence of the user arousal of the user and engagement of the user over a window of time at a time granularity selected by the user to facilitate user reflection of emotional states over the window of time the visualization comprises graphical objects that represent documents interacted with a user during the time window people interacted with during the time window or activities undertaken by the user during the time window. The methodology 700 completes at 714.

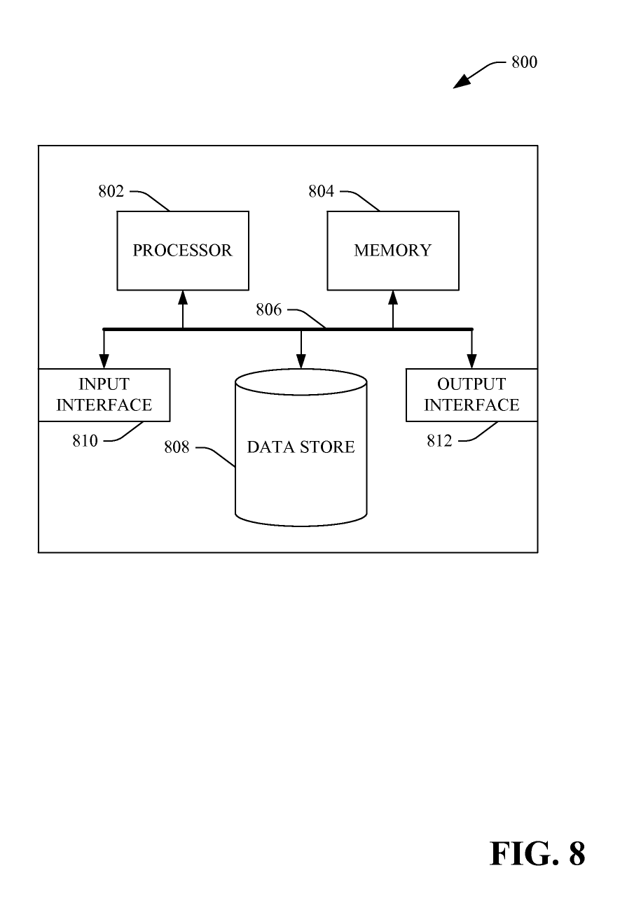

Now referring to FIG. 8, a high-level illustration of an exemplary computing device 800 that can be used in accordance with the systems and methodologies disclosed herein is illustrated. For instance, the computing device 800 may be used in a system that supports computing values that are indicative of affective states of a user. In another example, at least a portion of the computing device 800 may be used in a system that supports generating a visualization that facilitates user reflection over affective states over time. The computing device 800 includes at least one processor 802 that executes instructions that are stored in a memory 804. The memory 804 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store files, identities of people, identities of applications, URLs, content of web pages, etc.

The computing device 800 additionally includes a data store 808 that is accessible by the processor 802 by way of the system bus 806. The data store may be or include any suitable computer-readable storage, including a hard disk, memory, etc. The data store 808 may include executable instructions, sensor data, identities of people, attendees of meetings, etc. The computing device 800 also includes an input interface 810 that allows external devices to communicate with the computing device 800. For instance, the input interface 810 may be used to receive instructions from an external computer device, a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method, comprising:
receiving a plurality of data streams from a plurality of respective sensors, the plurality of data streams being indicative of at least one condition of a user;
computing values that are indicative of valence, arousal, and engagement of the user, respectively, for a window of time based at least in part upon the plurality of data streams, valence being indicative of an intrinsic feeling of positiveness or negativeness of the user during the window of time, arousal being indicative of an intensity of the feeling of the user during the window of time, and engagement being indicative of cognitive engagement of the user during the window of time;
repeating acts of receiving and computing for a plurality of different windows of time to compute pluralities of values that are indicative of valence, arousal, and engagement of the user for the plurality of different windows of time, respectively; and
rendering graphical objects on a display screen of a computing device that are indicative of the respective valence, arousal, and engagement of the user for the plurality of different windows of time.

2. The method of claim 1, wherein the values that are indicative of valence, arousal, and engagement are computed for windows of time of differing granularities.

3. The method of claim 2, wherein the graphical objects on the display screen are rendered relative to windows of time of a first granularity, the method further comprising:
receiving user input relative to at least one graphical object rendered on the display screen of the computing device; and
responsive to receiving the user input, rendering another plurality of graphical objects on the display screen of the computing device that are indicative of estimated states of valence, arousal, and engagement of a plurality of different windows of time of a second granularity that is different from the first granularity.

4. The method of claim 1, further comprising:
indexing data on the computing device based upon computed states of valence, arousal, and engagement that correspond to the respective data.

5. The method of claim 4, further comprising selectively displaying a subset of the data for each window of time represented on the display screen of the computing device.

6. The method of claim 5, the subset of the data selected based at least in part upon a computed uniqueness of the subset of the data relative to other data interacted with by the user during the respective window of time.

7. The method of claim 1, further comprising:
receiving input from the user at the computing device; and
responsive to receiving the input, outputting data to the user based at least in part upon the input and computed states of valence, arousal, and engagement when the input is received.

8. The method of claim 7, wherein the input is a query, and wherein the data is a document retrieved responsive to receipt of the query.

9. The method of claim 1, further comprising:
automatically outputting data for presentment to the user on the display screen of the computing device based at least in part upon computed states of valence, arousal, and engagement for a current point in time.

10. The method of claim 9, wherein the data for presentment to the user is additionally based at least in part upon computed states of valence, arousal, and engagement for previous windows of time.

11. The method of claim 1, wherein the plurality of sensors comprises a video camera, a depth sensor, a microphone, an electro-dermal activity sensor, and a global positioning system sensor.

12. The method of claim 11, further comprising:
monitoring interaction of the user with data on the computing device; and
computing at least one of valence, arousal, or engagement of the user based at least in part upon the interaction of the user with the data on the computing device.

13. A system, comprising:
a receiver component that receives a plurality of data streams from a plurality of respective sensors, the plurality of sensors configured to generate data that is indicative of at least one condition of a user;
an affect computer component that computes a value that is indicative of at least one affective state of the user based at least in part upon the plurality of data streams from the plurality of respective sensors, the at least one affective state being at least one of valence of the user, arousal of the user, or engagement of the user, the affect computer component computing values that are indicative of the at least one affective state of the user over a respective plurality of windows of time; and
a visualizer component that renders a time-series visualization on a display screen of a computing device, the visualization representing the at least one affective state of the user over the plurality of windows of time.

14. The system of claim 13, wherein the affect computer component computes values that are indicative of valence of the user, arousal of the user, and engagement of the user, respectively, and wherein the visualization rendered by the visualizer component comprises graphical objects that represent the valence of the user, arousal of the user, and engagement of the user over the plurality of windows of time.

15. The system of claim 13, wherein the affect computer component computes the value that is indicative of the at least one affective state of the user over windows of time of differing granularities, and wherein the visualizer component renders the time-series visualization based at least in part upon a granularity of time selected by the user.

16. The system of claim 13, further comprising an activity monitor component that monitors user interaction with documents on a computing device over time, and wherein the affect computer component computes the value that is indicative of the at least one affective state of the user based at least in part upon the user interaction with the documents on the computing device.

17. The system of claim 16, further comprising an indexer component that indexes the documents of the user based at least in part upon the user interaction with the documents and the value computed by the affect computer component for windows of time corresponding to the user interaction with the documents.

18. The system of claim 17, further comprising a data selector component that selects documents for inclusion in the visualization for respective windows of time represented in the visualization, the data selector component selecting the documents based at least in part upon estimated affective states of the user when interacting with the documents as computed by the affect computer component and uniqueness of the document versus other documents interacted with by the user in a respective window of time.

19. The system of claim 13, wherein the plurality of sensors comprise a video camera, a depth sensor, a microphone, an electro-dermal activity sensor, and a global positioning system sensor.

20. A computer-readable medium comprising instructions that, when executed by a processor, cause the processor to perform acts comprising:
receiving data from a plurality of sensors that is indicative of at least one condition of a user, the plurality of sensors comprising a camera and a depth sensor;
computing a first value that is indicative of valence of the user based at least in part upon the data received from the plurality of sensors;
computing a second value that is indicative of arousal of the user based at least in part upon the data received from the plurality of sensors;
computing a third value that is indicative of engagement of the user based at least in part upon the data received from the plurality of sensors;
repeating acts of receiving, computing the first value, computing the second value, and computing the third value a plurality of times to generate first values that are indicative of valence of the user over time, second values that are indicative of arousal of the user over time, and third values that are indicative of engagement of the user over time; and
generating a visualization that graphically depicts valence of the user, arousal of the user, and engagement of the user over a time window at a time granularity selected by the user to facilitate user reflection of emotional state over the time window; wherein the visualization comprises graphical objects that represent documents interacted with by the user during the time window.
